(19) United States
(12) Patent Application Publication
(10) Pub. No.: US 2025/0023748 A1
(43) Pub. Date: Jan. 16, 2025

(54) POWER OVER ETHERNET COMPUTER SYSTEM

(71) Applicant: Jesus Rodriquez, Brick, NJ (US)

(72) Inventor: Jesus Rodriquez, Brick, NJ (US)

(21) Appl. No.: 18/765,405

(22) Filed: Jul. 8, 2024

Related U.S. Application Data
(60) Provisional application No. 63/526,176, filed on Jul. 11, 2023.

(51) Int. Cl. H04L 12/10; G06F 1/26

(52) U.S. Cl. CPC H04L 12/10; G06F 1/266

(57) ABSTRACT

The present invention is a Power over Ethernet computer system, comprising: a processing unit; memory connected to the processing unit; at least one network adapter capable of receiving data and power connected to the processor and the memory; and a motherboard where the network adapter, memory, and processing unit electrically and mechanically interface.

### CROSS-REFERENCE TO RELATED APPLICATIONS

This application claims the benefit of priority under 35 USC 120 of U.S. application No. 63/526,176 filed Jul. 11, 2023. The disclosure of the prior applications is considered part of (and is incorporated by reference in) the disclosure of this application.

### BACKGROUND OF THE INVENTION

The present invention relates to a computer system (e.g., personal computer, server, enterprise server and network storage array), and more particularly to a computer and/or server system that receives both power and data via a Power of Ethernet (POE) system.

Power over Ethernet (POE) is a known technology that allows network cables to carry electrical power. Thus, PoE-enabled devices can receive power as well as data through the twisted pairs of an Ethernet cable. PoE can provide many advantages for installations, including reducing the time and expense of installing electrical power cables. PoE-enabled devices do not require mains AC electrical outlets to operate and PoE systems can also protect equipment from overload.

PoE has several advantages over traditional power systems used in homes and commercial buildings. For example, PoE systems are relatively low voltage, thus eliminating the need to run expensive high voltage wiring and conduit for lighting. In addition, installation of PoE, wiring can be faster than with traditional power systems because Ethernet cabling employs simple plug-in end connections. Where Ethernet cabling is already in place (i.e., for data transmission), PoE functionality can be achieved without the need for additional wiring installation.

With the increase in power provided by modern PoE systems, it would be desirable to provide a PoE computer system powered by a PoE system. The PoE computer system should be inexpensive, easy to configure, and use.

### SUMMARY

In a first embodiment the present invention is Power over Ethernet computer system, comprising: a processing unit; memory connected to the processing unit; at least one network adapter capable of receiving data and power connected to the processor and the memory; and a motherboard where the network adapter, memory, and processing unit electrically and mechanically interface.

In a second embodiment the present invention is a Power over Ethernet computer system, comprising: a motherboard, wherein the motherboard has a series of connectors; a processing unit connected to one of the series of connectors of the motherboard; memory connected to one of the series of connectors of the motherboard; at least one network adapter capable of receiving data and power connected to one of the series of connectors of the motherboard; and a battery connected to the at least one network adapters and the motherboard.

In a third embodiment the present invention is a computing device, comprising: a motherboard, wherein the motherboard has a series of connectors; a processing unit connected to one of the series of connectors of the motherboard; memory connected to one of the series of connectors of the motherboard; at least one network adapter capable of receiving data and power connected to one of the series of connectors of the motherboard; and a housing, wherein the motherboard is contained within the housing and the at least one network adapter is accessible through the housing.

### BRIEF DESCRIPTION OF THE DRAWINGS

FIG. 1 is a general overview of an ethernet network, in accordance with an embodiment of the present invention.

FIG. 2 is a general overview of an ethernet network, in accordance with another embodiment of the present invention.

### DETAILED DESCRIPTION OF THE INVENTION

The present invention provides a personal computing device with the advantage of both data and power from a single source versus the prior art which requires power and data to be over separate sources. The present invention is a Power over Ethernet (POE) computer system, such as a laptop, desktop, or all-in-one computer, server, or network storage array. As may be appreciated, aspects of the embodiments provide both the power delivery standard power to the device at varying data rates using Power Over Ethernet and TCP/IP communication in an integrated package. The power source is an Ethernet connection from which power is drawn.

Another advantage of the present invention is the ability for the system to be fully off the grid and a private system that is capable in terms of both power and data transfer. The present invention can be integrated into existing software ecosystem for monitoring and management. The PoE computing system allows for the automation of the unit through our existing infrastructure.

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates, which may need to be independently confirmed.

It must be noted that as used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

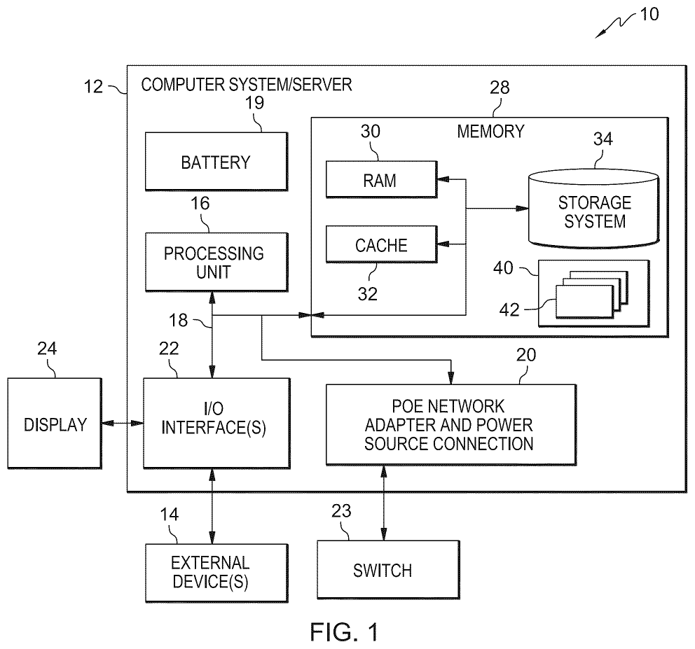

FIG. 1 depicts a block diagram of a computing node 10, in accordance with one embodiment of the present invention.

The PoE computer system 12 in computing node 10 is shown in the form of a general-purpose computer system. The PoE computing system or server 12 may be a laptop, desktop, micro server, TV set top box, IOT gateway, all-in-one computer, server or network storage array, or the like. The components of PoE computer system 12 may include, but are not limited to, one or more processors or processing units 16, a system memory 28, I/O interface(s) 22, a PoE network adapter and power source connection 20, and a bus 18 that couples various system components. The PoE computer system 12 through the I/O interface(s) is able to connect to various display(s) 24 and external device(s) 14. The I/O interfaces(s) 22 may be USB, micro-USB, Thunderbolt®, USB-C, VGA, DVI, HDMI, DisplayPort, firewire, audio and the like.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

System memory 28 can include computer system readable media in the form of volatile memory, such as random-access memory (RAM) 30 and/or cache memory 32. PoE computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

PoE computer system 12 typically includes a variety of computer system readable media. Such media may be any available media that is accessible by PoE computer system 12, and it includes both volatile and non-volatile media, removable and non-removable media.

PoE computer system 12 may also communicate with one or more external devices 14 such as a keyboard, a pointing device, a display 24, etc.; one or more devices that enable a user to interact with PoE computer system 12; and/or any devices (e.g., network card, modem, etc.) that enable PoE computer system 12 to communicate with one or more other computer systems. In some embodiments, external devices 14 may also include fans and the like for cooling the internal components. Such communication can occur via Input/Output (I/O) interfaces 22. The PoE computer system 12 is able to provide adequate power to these display(s) 24 and external device(s) 14 through the PoE network adapter and power source connection 20. The PoE network adapter and power source connection 20 communicates with the other components of PoE computer system 12 via bus 18.

PoE computer system 12 is able to communicate with one or more networks such as a local area network (LAN), a general wide area network (WAN), and/or a public network (e.g., the Internet) via PoE network adapter and power source connection 20. In some other embodiments, PoE computer systems 12 are used to create a private mesh network used to communicate directly with various sensors and lights. PoE computer system 12 also receives power via the PoE network adapter and power source connection 20. The power which is received and/or converted by the PoE network adapter and power source connection 20 is adequate to run the PoE computer system 12 as well as the display(s) 24 and the external device(s) 14. In some embodiments, there are multiple PoE network adapter and power source connection 20 and through the multiple connections, the power received can be multiplied by the number of connections or each PoE network adapter and power source connection 20 can be used to power specific displays, external devices, or internal components.

For exemplary purposes, a typical ethernet wiring is used to explain the method of transferring both power and data through a single wire, however other wiring systems can be implemented by the present invention provides that the wiring system provides both power and data via the single cabling. A typical ethernet cable is an RJ-45 Socket. The connectors can have a fixed DC voltage output at, but not limited to 5/9/2012/24/48v.

The PoE network adapter and power source connection 20 provides for the transfer of both data and power to the PoE computer system 12 via a single port while also monitoring the power requirements of the computer node 10 so that either adequate power is provided to all components or a notice/warning is provided that the power requirements of the computer node 10 are beyond the capability of the power received. With typical PoE systems the power using a IEEE802.3af is 15.4W. However other systems may have more or less power output per port. Thus, the PoE computer system 12 is able to determine the minimum and maximum power requirements of the computer 10 and determine if the power received via the PoE network adapter and power source connection 20 is adequate. If the power required is greater than the power received, the computer 10 may send a warning to the user or may turn off various external devices or displays until the power requirements are met. The computer 10 is able to determine which devices are being used and which are not to assist in the determination to turn off various devices or displays. In some embodiments, multiple PoE network adapter and power source connection 20 may be used to increase the minimum power received by the computer node 10. If the computer 12 determines that the computer 12 and the displays 24 and external devices 14 have a greater power requirement than what can be delivered through the switch 23. The computer 12 determines which of the displays 24 or the external devices 14 to turn off.

In one embodiment, the PoE computer system 12 has an integrated battery 19 or power supply in the motherboard that directly connects to the PoE network adapter and power source connection 20 to receive the power and data and transfer the power directly through the motherboard. In other embodiments, the PoE network adapter and power source connection 20 is connected to the motherboard via an interface.

The PoE computer system 12 has a lower power consumption of around ten (10) watts to operate. Ten (10) watts of power is substantially similar to 10 volts and 1 amp of current. There is no requirement for high voltage power, as the PoE network adapter and power source connection 20 has an internal battery 19 or power supply that is able to adequately convert the power received from the switch 23 through the PoE network adapter and power source connection 20 ethernet connection to provide the power for the PoE computing system 12 components and all external devices 14. The battery 19 may be integrated into the motherboard or may be directly connected to the PoE network adapter and power source connection 20. In some embodiments, there is a power adapter that is able to perform the power conversion. The power conversion may be DC to DC. Embodiments of the present invention are advantageous because they reduce the power requirements of the computing node 10 by utilizing energy efficient devices and components.

It should be understood that although not shown, other hardware and/or software components could be used in conjunction with PoE computer system 12. Examples include, but are not limited to: microcode, device drivers, redundant processing units, external disk drive arrays, RAID systems, tape drives, and data archival storage systems, etc. These additional hardware and/or software components are based on the overall power requirements and the maximum power that the PoE computer system 12 is able to receive via the PoE network adapter and power source connection 20.

In the depicted embodiment, a switch 23 is shown connected to the PoE network adapter and power source connection 20. A switch 23 typically is connected to a direct power source as well as the various PoE computer systems 12 and/or devices and provides the transfer of data between the devices as well as providing the necessary power through the cable/wiring to the PoE computer system 12 and/or devices.

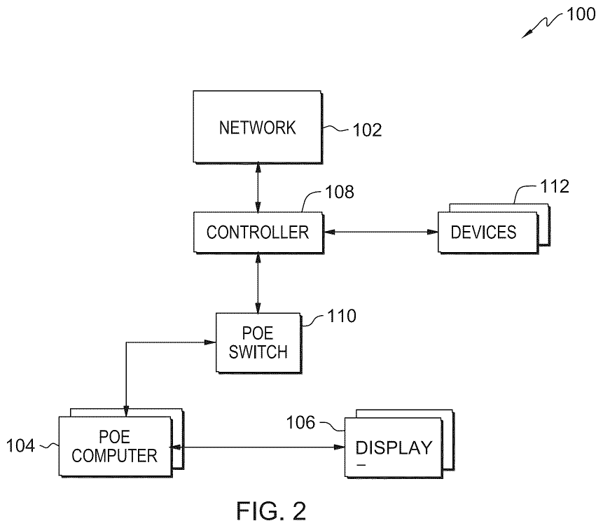

FIG. 2 depicts a block diagram of a computing environment 100, in accordance with one embodiment of the present invention. In the depicted embodiment, computing environment 100 includes network 102, controller 108, POE switch 110, PoE computer system 12, Display, and devices 112. Computing environment 100 may include additional servers, computers, or other devices not shown.

Network 102 may be a local area network (LAN), a wide area network (WAN) such as the Internet, any combination thereof, or any combination of connections and protocols that can support communications between PoE computer system 12 and server 104 in accordance with embodiments of the invention. Network 102 may include wired, wireless, or fiber optic connections.

The PoE Computer 104 as described above is the computer device which is powered and transmits data via the single wired connection. Display 106 are connected to the PoE Computer 104. In various embodiments, each PoE Computer 104 may have multiple displays 106.

In additional embodiments, display 106 may be connected to the PoE computer 104 via a PoE connection. In some embodiments, the display 106 ranges in size from 24-55″. In some embodiments display 106 use a PoE splitter to connect the PoE computer 104.

Controller 108 is used to control the delivery of power and send and receive data from the power source equipment to the devices. Controller 108 is shown connected to the switch 110 as well as directly connected to the devices 112. Controller 108 is able to send commands to devices 112, as well as receive data from devices 112. This controller 108 is connected to a switch 110 which is connected to multiple PoE computers 104 and is able to receive commands from the PoE computer 104 as well as send data to the PoE computer 104.

POE Switch 110 is used to deliver power and send and receive data to the various devices connected to the POE switch. The POE switch 110 is connected to the PoE computer 104 through cables. The POE switch 110 provides the power for the PoE computer 104 and for data to be transferred to and from the PoE computer 104. POE switch 110 is able to convert the power to a usable power, which is then sent to the preconfigured PoE computer 104. In some embodiments, where devices 112 are directly connected to the POE switch 110, the Poe Switch 110 is able to provide power and send and receive data from the devices 112.

In some embodiments the controller 108 and the POE Switch 110 are a single component.

The Controller 108 and the POE Switch 110 are able to control the various sensors, devices, and PoE Computers 104 connected to them (as well as provide power) and are able to monitor the power consumption of these components. In some embodiments, the Controller 108 and/or the POE Switch 110 is able to automatically put them to sleep when not in use, to either reduce the power consumption or the system or to recharge internal batteries where present.

Devices 112 are various devices, sensors, or equipment which can be connected to the controller 108 (or the POE Switch 110) via the PoE cabling system. The devices 112 maybe, but not limited to, lights, telephones, cameras, badge readers, access points, routers, multi-sensors, motion sensors, humidity sensors, temperature sensors, ultrasound sensors, infrared sensors, proximity sensors, fire alarm systems, HVAC systems, security systems, and the like.

While this invention has been described in conjunction with the specific embodiments outlined above, it is evident that many alternatives, modifications, and variations will be apparent to those skilled in the art. Accordingly, the preferred embodiments of the invention, as set forth above, are intended to be illustrative, not limiting. Various changes may be made without departing from the spirit and scope of this invention.

It will be further understood that various changes in the details, materials, and arrangements of the parts which have been described and illustrated in order to explain the nature of this invention may be made by those skilled in the art without departing from the scope of the invention as expressed in the following claims.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

1. A Power over Ethernet computer system, comprising:
a processing unit;
memory connected to the processing unit;
at least one network adapter capable of receiving data and power connected to the processor and the memory; and
a motherboard where the network adapter, memory, and processing unit electrically and mechanically interface.

2. The Power over Ethernet computer system of claim 1 further comprising, an I/O interface.

3. The Power over Ethernet computer system of claim 2 further comprising, at least one display connected to the I/O interface.

4. The Power over Ethernet computer system of claim 2 further comprising, at least one external device connected to the I/O interface.

5. The Power over Ethernet computer system of claim 1, wherein the computer system receives through the at least one network adapter 10 watts of power.

6. The Power over Ethernet computer system of claim 1, further comprising a power supply connected to the at least one network adapters.

7. The Power over Ethernet computer system of claim 1, wherein the at least one network adapter is able to determine the minimum power requirements based on the computer system and the display and external devices power requirements.

8. A Power over Ethernet computer system, comprising:
a motherboard, wherein the motherboard has a series of connectors;
a processing unit connected to one of the series of connectors of the motherboard;
memory connected to one of the series of connectors of the motherboard;
at least one network adapter capable of receiving data and power connected to one of the series of connectors of the motherboard; and
a battery connected to the at least one network adapters and the motherboard.

9. The Power over Ethernet computer system of claim 8 further comprising, at least one I/O interface integrated into the motherboard.

10. The Power over Ethernet computer system of claim 9 further comprising, at least one display connected to at least one of the I/O interface.

11. The Power over Ethernet computer system of claim 10 further comprising, at least one external device connected to at least one of the I/O interface.

12. The Power over Ethernet computer system of claim 11, wherein the processor determines a minimum power requirement based the connected display and the connected external device, wherein if it is determined that the minimum power requirement is beyond the computer systems ability, selecting one of the displays or external devices to turn off until the power requirements are met.

13. The Power over Ethernet computer system of claim 8, wherein the at least one network adapter is able to convert the power received.

14. The Power over Ethernet computer system of claim 8, wherein the at least one network adapter is able to receive a wireless and a wired connection.

15. The Power over Ethernet computer system of claim 8, further comprising a housing, wherein the motherboard is contained within the housing.

16. A computing device, comprising:
a motherboard, wherein the motherboard has a series of connectors;
a processing unit connected to one of the series of connectors of the motherboard;
memory connected to one of the series of connectors of the motherboard;
at least one network adapter capable of receiving data and power connected to one of the series of connectors of the motherboard; and
a housing, wherein the motherboard is contained within the housing and the at least one network adapter is accessible through the housing.

17. The Power over Ethernet computer system of claim 16 further comprising, at least one I/O interface connector integrated into the motherboard and accessible through the housing.

18. The Power over Ethernet computer system of claim 16, further comprising a battery connected to the at least one network adapters and the motherboard.

19. The Power over Ethernet computer system of claim 16, wherein the at least one network adapter converts the power received.

20. The Power over Ethernet computer system of claim 16, wherein there are two or more of the network adapters, the power received is multiplied by the number of connections.
